(19) United States
(12) Patent Application Publication
(10) Pub. No.: US 2019/0255803 A1
(43) Pub. Date: Aug. 22, 2019

(54) THERMAL INSULATING MATERIAL

(71) Applicant: BLIZZARD PROTECTION SYSTEMS LTD., Bethesda Gwynedd (GB)

(72) Inventor: Derek John RYDEN, Bethesda Gwynedd (GB)

(21) Appl. No.: 16/346,274

(22) PCT Filed: Oct. 30, 2017
(86) PCT No.: PCT/GB2017/053251

§ 371 Date: Apr. 30, 2019

(30) Foreign Application Priority Data
Nov. 1, 2016 (GB) 1618420.2

(51) Int. Cl. B32B 5/04; B32B 5/02; B32B 5/26; B32B 7/14; B32B 27/12; B32B 27/08; B32B 27/32

(52) U.S. Cl. CPC B32B 5/04; B32B 2323/046; B32B 5/028; B32B 5/26; B32B 7/14; B32B 27/12; B32B 27/08; B32B 27/32; B32B 2255/10; B32B 2255/205; B32B 2307/304; B32B 2307/31; B32B 2307/51; B32B 2307/7242; B32B 5/022

(57) ABSTRACT

An insulating material is disclosed. The material comprises first, second and optionally third layers of primary material arranged to opposite sides of at least one elastic element, such that the insulating material can change between a first configuration wherein the at least one elastic element is stretched such that the at least one layer of primary material lies adjacent the at least one elastic element, and a second configuration in which the at least one layer of primary material is bowed with respect to the at least one elastic element. When bowed in this way, there is formed at least one cavity. The primary material of at least one of the at least one layer is a laminate of a polymer film and a non-woven textile.

The present invention relates to a thermal insulating material. Such a material is particularly suited for use in emergency equipment and offers low bulk with relatively good thermal insulation.

In WO-A-00/00051, the present inventor disclosed multi-layered materials and articles made from them that provided improved heat insulation without an increase in weight as compared with conventional textile insulating materials. These articles can be used to protect an injured or incapacitated person against the effects of cold.

The inventors have now realised that these materials could find application in operating theatres with suitable adaptation to the nature of the primary layers from which the materials are formed.

According to a first aspect of the present invention, there is provided an insulating material, comprising first and second layers of primary material arranged to opposite sides of at least one elastic element, such that the insulating material can change between a first configuration wherein the at least one elastic element is stretched such that the at least one layer of primary material lies adjacent the at least one elastic element, and a second configuration in which the at least one layer of primary material is bowed with respect to the at least one elastic element so as to form at least one cavity, wherein the primary material of at least one of the at least one layer is a laminate of a polymer film and a non-woven textile.

Compared with the material disclosed in WO-A-00/00051, material embodying this invention is quieter to handle as a result of the composite form of the primary material.

The polymer film is advantageously low-density polyethylene, which provides superior tensile strength.

At least layer of the primary material may be in the form of a sheet

One or each sheet may include a silver-coloured coating, such as a coating of silver-coloured metal, particularly aluminium, applied by vacuum deposition. Alternatively, the coating may be a silver-coloured ink. The coating is preferably broken-up discontinuous on the surface. This ensures that there is no large-scale path for the conduction of electricity over the film.

The material of the elastomeric elements may be a thread that comprises a yarn having an elastomeric core and a textile coating. The elastomeric core may be a non-latex-containing elastomer, such as elastane.

The textile coating may include relatively low-melting point fibres which are capable of forming a heat-welded bond with the polymer film and may also include relatively high-melting point fibres which are able to retain their tensile strength at the temperatures used to heat seal the relatively low-melting point fibres.

Preferably, the primary material acts to provide protection against water penetration and/or airflow, and the secondary material acts to cause the layers of primary material to move apart from one another or to become bowed with respect to one another in order to form insulating pockets of air between the layers. The primary material may be air and/or water vapour permeable. This can help avoid build-up of moisture due to condensation.

Preferably, the secondary material exhibits elasticity.

Preferably, the secondary material is formed of an elastic layer (that is, a layer which exhibits elasticity), for example formed of elastics or rubber. Alternatively, the secondary layer may be formed of a textile material which is resiliently stretchable. As another alternative, the secondary material may include a net or a mesh of elastic elements.

In a first embodiment of the present invention, layers of primary material are placed adjacent to layers of secondary material in an alternating manner, the secondary material being in a state of tension. The layers are then attached to one another at spaced-apart attachment points. Once the tension is released, the secondary layers contract thereby causing the spaced-apart attachment points to move nearer to one another. This in turn causes the primary material to bow between the attachment points thereby giving rise to the creation of chambers which impede the flow of air within the material and hence provide insulation.

Advantageously, the secondary material is provided in the form of strips arranged parallel to one another. This has the effect of controlling the degree of tension required (per unit width) to stretch the insulating material to its maximally stretched configuration.

The outermost layers of the insulating material may be substantially gas-impermeable and a sealable opening is provided for controlling the flow of fluid, for example a gas such as air, into the interior of the insulating material. The sealable opening may communicate with a manifold for distributing the fluid.

At least one layer of secondary material may be interposed between the first and second sheets of a primary material, the secondary material being resiliently deformable such that the insulating material can change between a first configuration in which the first and second sheets of primary material are separated from each other by a first distance to a second configuration, in which at least portions of the first and second sheets of primary material become separated from each other by a distance greater than the first distance.

The primary material may have at least one of the following properties: it is light, it is thin, it is substantially waterproof, it is flexible, it reflects heat, and it is permeable to air.

From a second aspect, the invention provides an article made wholly or partly form an insulating material that embodies the invention as defined from its first aspect. Examples of such articles include (but are not limited to) a blanket, a garment and a sleeping bag.

The attachments between the primary material and the elastic element may be made so as to directly bond the materials to one another. Alternatively the attachments may hold the materials in the spaced apart relationship. Mechanical fasteners may be used, as may adhesives. Furthermore, heat may be applied to the materials to cause them to mould together at the attachment points.

Embodiments of the invention will now be described in detail, by way of example, and with reference to the accompanying drawings, in which:

FIG. 1 is a cut-away plan view through an insulating material constituting a first embodiment of the present invention;

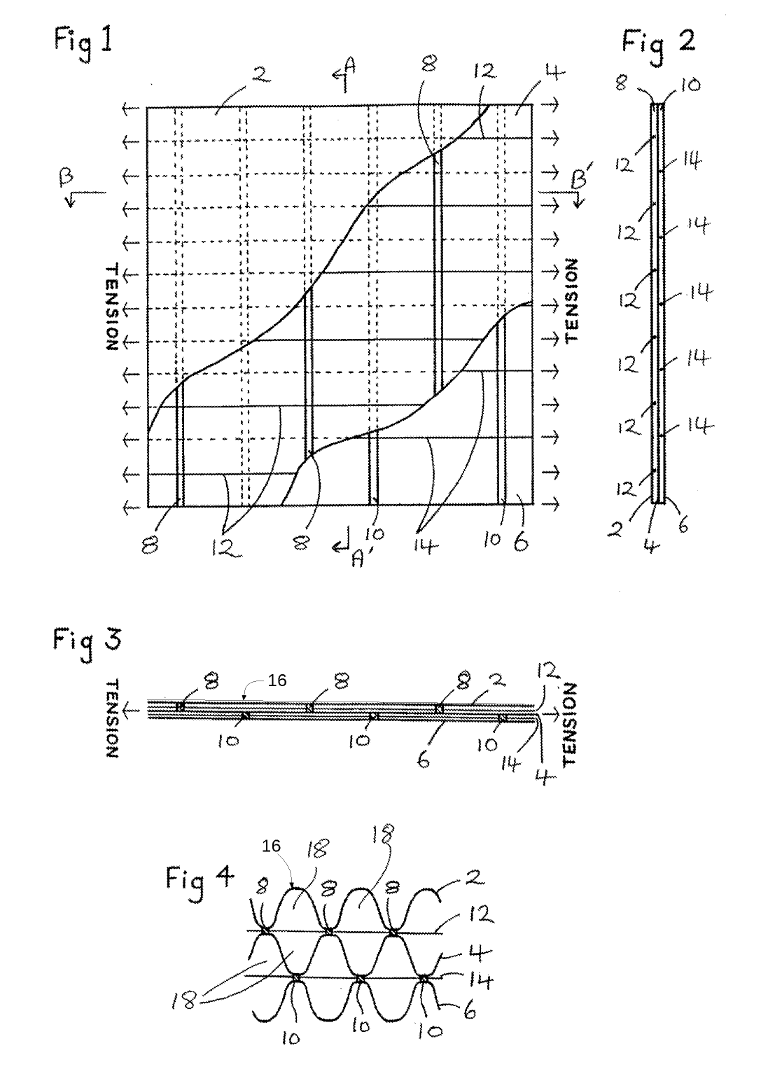

FIG. 2 is a cross-section through the embodiment shown in FIG. 1 along the line A-A′;

FIG. 3 is a cross-section through the embodiment shown in FIG. 1 along the line B-B′;

FIG. 4 is a cross-section along the line B-B′ when the tension in the material has been released, allowing it to obtain its operating state;

FIG. 5 is a cut-away plan view through an insulating material constituting a second embodiment of the present invention;

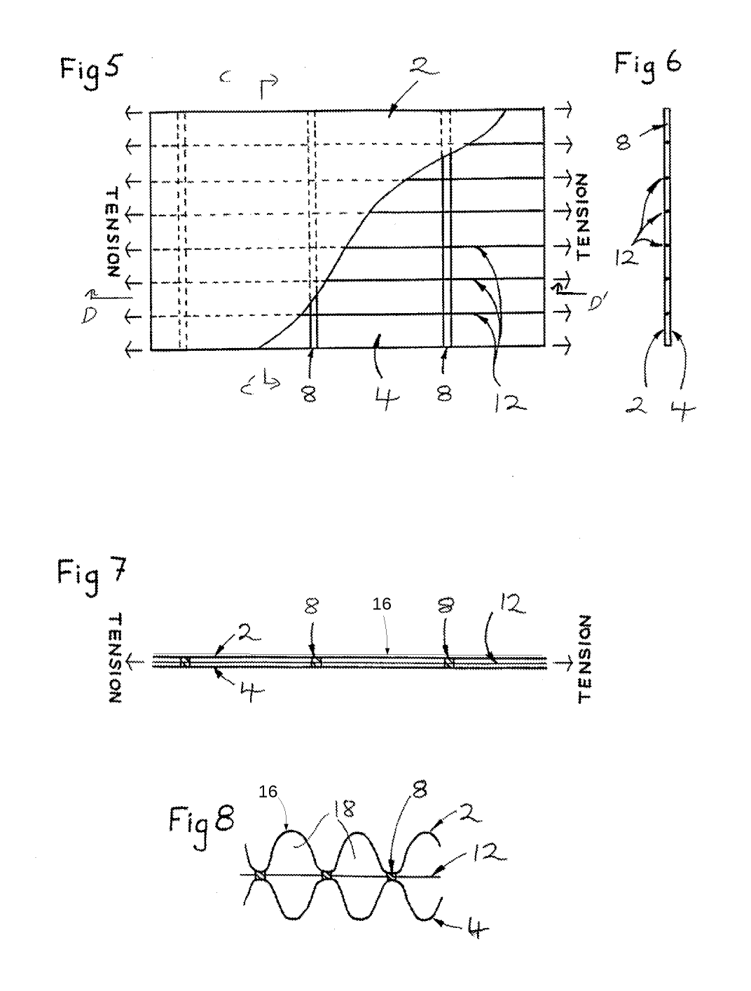

FIG. 6 is a cross section along the line C-C′ of FIG. 5;

FIG. 7 is a cross section along the line D-D′ of FIG. 5;

FIG. 8 is a view along the line D-D′ of FIG. 5 when the insulating material is in its operating state;

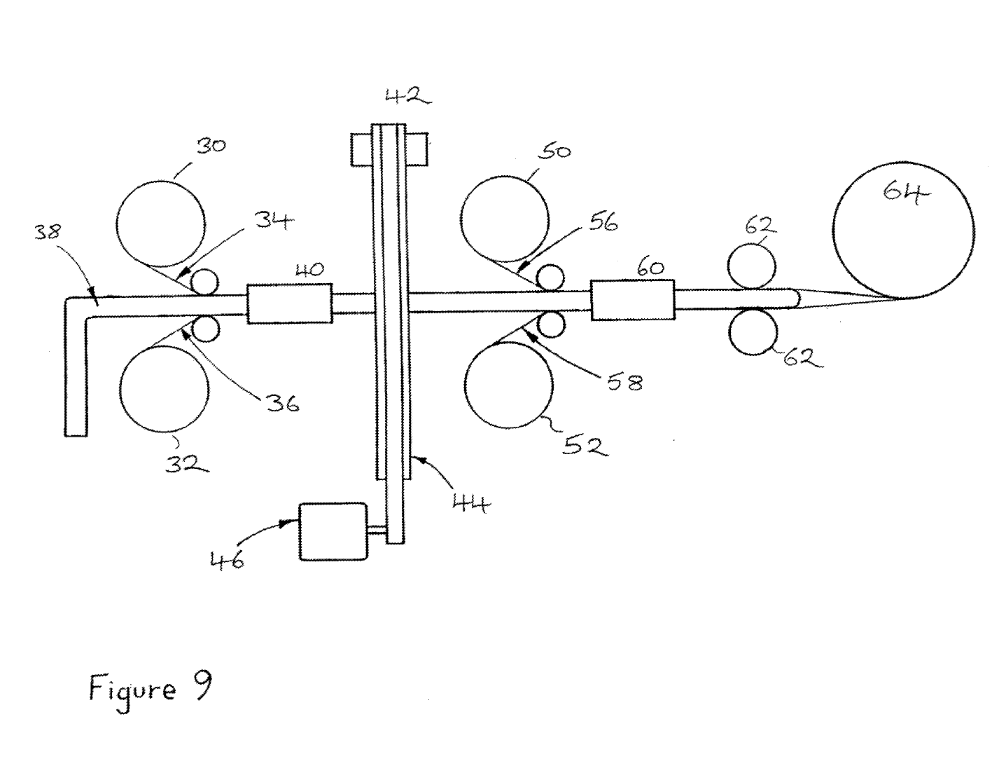

FIG. 9 schematically illustrates a first arrangement for manufacture of the insulating material;

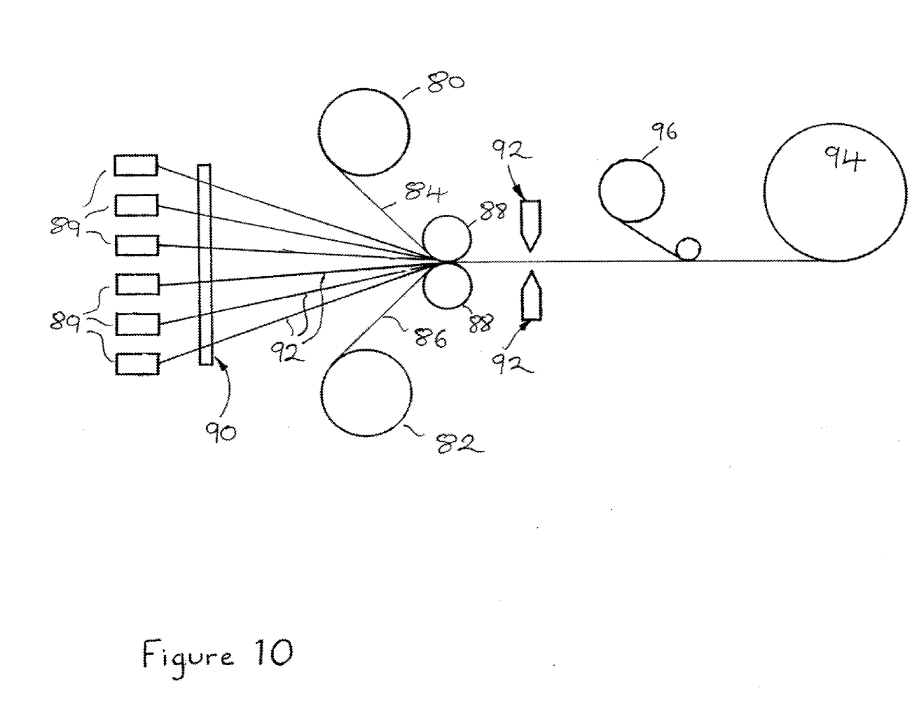

FIG. 10 schematically illustrates a second arrangement for manufacturing the insulating material;

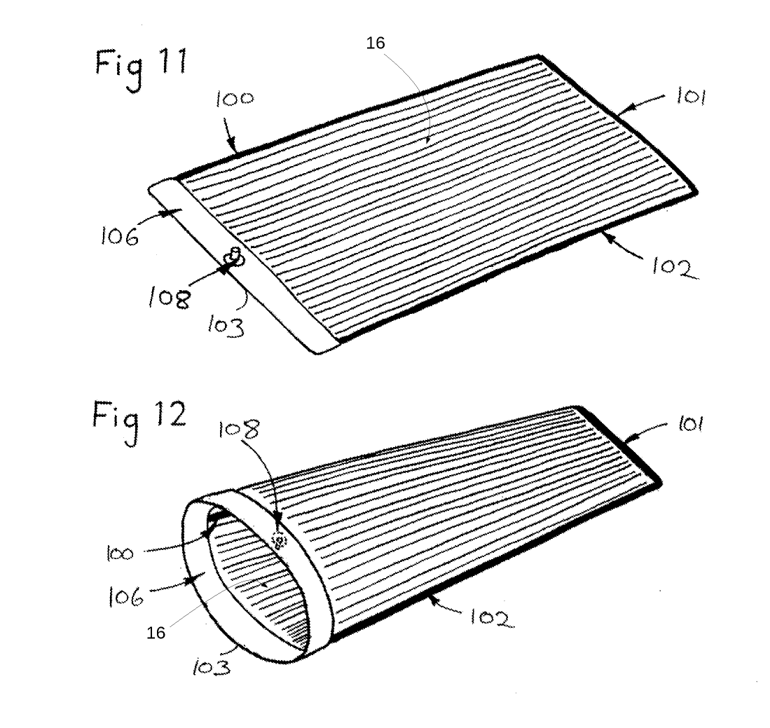

FIG. 11 is a perspective view of a blanket formed using the material and having a manifold at one end thereof; and

FIG. 12 is a perspective view of a sleeping bag formed of the material constituting an embodiment of the present invention.

A first embodiment of the present invention, as illustrated in FIGS. 1, 2, 3, and 4, comprises first, second, and third sheets, 2, 4, 6 respectively, of thin polymer sheet.

The inner and the outer sheets 2, 6 are made from a laminate of a low-density polyethylene film and a non-woven textile, that includes polypropylene. The film is coated with a coating 16 that is formed by vacuum deposition of a silver-coloured metal, aluminium in this embodiment, onto the film. The film formed by the deposition process is not continuous, but is instead fragmented, such that the film does not serve as a conductor of electricity at the scale of the film as a whole.

The second sheet is formed from transparent low-density polyethylene.

The first sheet 2 is attached to the second sheet 4 at regular, spaced-apart intervals by parallel linear strips of adhesive 8 or by heat sealing. Similarly, the second and third sheets 4 and 6 are attached to each other at regular intervals by parallel linear strips of adhesive 10. The strips of adhesive 8 and 10 run parallel to one another and are offset with respect to one another by a distance substantially equal to half the interval between the strips 8 that interconnect the first and second sheets.

A plurality of parallel elastic elements, for example in the form of elastic filaments 12 are disposed at regular intervals between the first and second sheets 2 and 4. The filaments 12 run perpendicular to the longitudinal direction of the strips of adhesive. Similarly, a further set of parallel elastic elements 14 are disposed at regular intervals between the second and third sheets 4 and 6, respectively. These filaments run parallel to the first group of filaments 12, have an inter-filament interval substantially the same as that of those filaments between the first and second sheets, and are offset with respect to those filaments by substantially half the inter-filament interval.

The filaments 12, 14 are in the form of a yarn comprising an elastomeric core with a textile covering. The core is a non-latex-containing elastomer, such as elastane. The textile covering contains two types of fibre: relatively low-melting point fibres which are capable of forming a heat-welded bond with the polymer film layers 2, 4, 6 and relatively high-melting point fibres which are able to retain their tensile strength at the temperatures used to heat seal the low-melting-point fibres during manufacture.

The filaments 12 and 14 are attached to the adjacent sheets 2, 4, 6 by the strips of adhesive 8 and 10 at those regions where the filaments intercept the strips of adhesive or by heat sealing the low-melting-point fibres to the polymer sheets.

The filaments 12 and 14 are arranged such that they are under tension when the sheets 2,4 and 6 lie parallel to one another, as shown in FIG. 3. This corresponds to the configuration of the material during manufacture and during its “stowed” condition.

When the material is unpacked, and the tension released, the filaments 12 and 14 contract thereby reducing the distance between adjacent adhesive strips to less than the width of the first, second or third sheets of material between the adhesive strips. This causes the sheets to become bowed, as shown in FIG. 4, thereby causing the creation of cavities 18. In use, these cavities trap air between the adjacent sheets 2, 4 and 6, and this entrapped air provides a relatively efficient insulator.

A second embodiment of the present invention is illustrated in FIGS. 5 to 8. The second embodiment is similar to the first embodiment, but only comprises first and second sheets, 2 and 4, respectively, of thin polymer sheets. A first of the sheets 2 has one surface coated by vacuum deposition with a layer of aluminium 16. These sheets are attached to one another at spaced-apart, regular intervals by parallel linear strips of adhesive 8 or by heat sealing. As with the first embodiment, a plurality of elastic elements, for example in the form of rubber filaments 12, traverse the material under tension, in a direction such that the longitudinal axes of the rubber filaments are perpendicular to the direction of the adhesive strips. The rubber filaments 8 are attached to the sheets 2 and 4 by the adhesive at the points of intersection between the filaments and the adhesive strips.

As with the first embodiment, the material can move between a storage configuration, as shown in FIG. 7, wherein the first and second sheets 2 and 4 respectively, of primary material are substantially parallel to one another and the thickness of the material is minimised, to a second configuration as shown in FIG. 8 wherein the tension is released from the filaments 12 and these cause the first and second sheets to take a bowed or corrugated configuration thereby entraining pockets of air 18 between the sheets.

It will be appreciated that modifications can be made to the embodiments within the scope of the invention. For instance, the linear strips of adhesive may be replaced by other adhesive patterns, for example spots of adhesive in a regular pattern or a regular array or more complex geometric patterns of adhesive. As a further alternative, intersecting lines of adhesive may be provided. Similarly the elastic elements are not restricted to being essentially one-dimensional filaments running parallel to one another, but other more complex shapes may be used such as an intersecting square or triangular grid of filaments, or other shapes which may involve the deposition of individual filaments into the material or may be formed by punching holes out of a sheet of elastic material.

In a further alternative embodiment, the space between the first and second sheets 2, 4 may be filled by a resiliently-deformable open-cell foam. Thus air can be evacuated from the structure in order that the foam becomes compressed by atmospheric pressure acting on it. In order to deploy the insulating material to its working condition, air can be admitted into the space between the first and second sheets thereby enabling the foam to expand.

The insulating material may be manufactured in a number of ways. For simplicity, the method of manufacture will be described with respect to the second embodiment since this is structurally simpler than the first embodiment.

An apparatus for the manufacture of the material is schematically illustrated in FIG. 9. The apparatus is arranged to form the insulating material in a continuous tube. Rolls 30 and 32 hold continuous sheets of the primary material, at least one of which has a vacuum-deposited coating of aluminium applied to one of its surfaces, which will be used to form the innermost skin of the tube. The sheets of the material 34 and 36 are pulled from the rolls 30 and 32 respectively, and caused to run against the upper and lower surfaces of a cantilevered former 38. A joining station 40, for example in the form of a tape dispenser serves to seal the edges of the sheets 34 and 36 together thereby forming a tube of material. The tube then passes through a processing station 42 which serves to dispose the elastic filaments around the tube.

The processing station 42 comprises a rotating annulus 44 driven by a motor 46. The rotating annulus 44 encircles the cantilevered former 38. The processing station 42 wraps an elastic filament around the tube of primary material in a helical fashion as the tube advances through the rotating annulus 44. Rollers 50 and 52 hold further layers of primary material which serve to form the top and bottom sheets 56 and 58 of the outermost skin of the tube.

The sheets 56 and 58 are disposed against the tube prior to it passing through a second joining station 60 which seals the edges of the sheets 56 and 58 together. Thus far, the apparatus has formed two coaxial tubes of primary material, with the innermost tube being helically over-wound by an elastic filament. The material is then passed between heated ribbed rollers 62 which form narrow longitudinal seams joining the inner and outer layers of primary material. The finished material is then wound onto a roll 64 for storage.

In an alternative arrangement to that described, the longitudinal seems joining the inner and outer layers together may alternatively be produced using adhesive, for example, by pre-coating the outer surface of the inner layer of primary material, or the inner surface of the outer layers of primary material, with continuous strips of contact adhesive such that the seams are formed when the inner and outer layers of primary material come into contact with one another.

A second method of manufacture is schematically illustrated in FIG. 10.

This method is directed to the manufacture of sheets of material. Spools 80 and 82 hold upper and lower sheets 84 and 86 respectively of primary material, at least one of which sheets has a metal coating applied to one of its surfaces. A plurality of spools 89 hold elastic filaments and these are directed through a tensioning and guide arrangement 90 such that the elastic filaments 92 are sandwiched between the upper and lower sheets of primary material 84 and 86 as the insulating material is drawn between powered rollers 88. Thus, the filaments run parallel to the longitudinal axis of the sheet of insulating material and are disposed at regular intervals across the width of the material.

The material then passes between a pair of reciprocating heated elements 92 which form transverse, heat-welded seams at regular intervals along the material.

The material is then wound on to a storage roll 94.

An additional spool 96 may be provided to adhere further tape along the edge of the material in order to form a manifold.

It will be appreciated that a further method of manufacture can involve introducing parallel corrugations into the sheets prior to attaching these to sheets of elastic material, the elastic material being in a non-tensioned or reduced tension configuration.

The material may be employed in the construction of blankets, sleeping bags and other garments. FIG. 11 is a perspective view of a blanket constructed from the material. The peripheral edges 100, 101, 102, 103 are sealed in an airtight manner in order to prevent air from gaining entry into the interior of the insulating material. A manifold 106 is provided at one end of the blanket, in gas flow communication with the cavities formed intermediate each pair of longitudinal glue lines, such that a fluid, for example air, can be introduced into the material under pressure. A closeable opening 108, for example in the form of a mouth piece, is provided such that air may be introduced into the material. After manufacture, and before use, the material may be stored in a configuration in which its volume is minimised, this may either be obtained by storing the material under tension, or, by reducing the air pressure within the interior of the material such that its volume is reduced by atmospheric pressure acting thereon. It is preferable that the material be allowed to take up the “operational” configuration as shown in FIG. 4, prior to evacuation of the air from the interior of the material.

A sleeping bag, as shown in FIG. 12, can be constructed in a similar manner.

In an alternative form of construction one or both outer layer of the material is perforated to allow air to pass through it This allows the item to be self-inflating, so avoiding the need to provide airtight seals or a manifold.

In a further form of construction, one or more of the peripheral edges 101 and 103 are not sealed in an airtight manner. This also allows the item to be self-inflating, so avoiding the need to provide airtight seals or a manifold.

It is thus possible to provide the material which can be stored in a very compact configuration and yet, upon use, can expand to provide good thermal insulation by virtue of holding gas entrained in a plurality of cavities. Other fastenings, for example stitching or rivets, may be used in place of the adhesive to hold the layers together.

1. An insulating material, comprising first and second layers of primary material arranged to opposite sides of at least one elastic element, such that the insulating material can change between a first configuration wherein the at least one elastic element is stretched such that the at least one layer of primary material lies adjacent the at least one elastic element, and a second configuration in which the at least one layer of primary material is bowed with respect to the at least one elastic element so as to form at least one cavity, characterised in that the primary material of at least one of the at least one layer is a laminate of a polymer film and a non-woven textile.

2. An insulating material according to claim 1 in which the polymer film is low-density polyethylene.

3. An insulating material according to claim 1 or claim 2 in which a reflective coating is provided on the polymer film.

4. An insulating material according to claim 3 in which the reflective coating is a coating of metal.

5. An insulating material according to claim 4 in which the metal coating is discontinuous on the surface.

6. An insulating material according to any preceding claim comprising a plurality of layers of primary material and a plurality of layers of elastic elements arranged in an alternating fashion.

7. An insulating material according to claim 6 in which the material of the elastomeric elements is a thread that comprises a yarn having an elastomeric core and a textile coating.

8. An insulating material according to claim 7 in which the elastomeric core is a non-latex-containing elastomer.

9. An insulating material according to claim 8 in which the elastomeric core is elastane.

10. An insulating material according to any one of claims 7 to 9 in which the textile coating includes relatively low-melting point fibres which are capable of forming a heat-welded bond with the polymer film.

11. An insulating material according to claim 10 in which the textile coating includes relatively high-melting point fibres which are able to retain their tensile strength at the temperatures used to heat seal the relatively low-melting point fibres.

12. An insulating material according to any preceding claim in which the primary material comprises a material in the form of a sheet

13. An insulating material according to any preceding claim in which the at least one elastic element is in the form of a sheet

14. An insulating material according to any preceding claim in which the at least one elastic element is provided as an array of filaments or strips.

15. An insulating material according to any preceding claim in which the elastic elements are formed as a net or a mesh.

16. An insulating material according to any preceding claim in which the at least one elastic element is attached to an adjacent layer of primary material at spaced apart attachment regions.

17. An insulating material according to claim 15 in which the at least one elastic element is disposed between first and second layers of primary material and between second and third layers of primary material, and in which the attachment regions with the first layer and the second layer are offset with respect to the attachment regions with the second layer and the third layer.

18. An insulating material according to claim 16 or claim 16 in which the attachment regions are arranged in a regular array.

19. An insulating material according to any preceding claim in which the outermost layers of the insulating material are substantially gas-impermeable, and at least one sealable opening is provided for the admission of gas into the material.

20. An insulating material according to any preceding claim in which the attachment between the primary material and the at least one elastic element is one of mechanical attachment, heat sealing or adhesive attachment

21. An insulating material according to any preceding claim further comprising at least one layer of a secondary material interposed between the first and second sheets of a primary material, the secondary material being resiliently deformable, such that the insulating material can change between a first configuration in which the first and second sheets of primary material are separated from each other by a first distance to a second configuration in which at least portions of the first and second sheets of primary material become separated from one another by a distance greater than the first distance.

22. An insulating material according to claim 21 in which the secondary material is a heat-sealable polymer film.

23. An insulating material according to claim 21 in which the secondary material is transparent low-density polyethylene.

24. An article of clothing made wholly or partly from an insulating material according to any preceding claim.

25. A sleeping bag made wholly or partly from an insulating material according to any one of claims 1 to 19.

26. A blanket or thermal wrap wholly or partly made from an insulating material claimed in any one of the claims 1 to 20.
